(19) United States
(12) Patent Application Publication
(10) Pub. No.: US 2007/0124241 A1
(43) Pub. Date: May 31, 2007

(54) Vanity Mailbox system

(76) Inventor: Dale C. Newton, Macon, GA (US)

Correspondence Address: GEORGE R. REARDON, 3356 STATION COURT, LAWRENCVILLE, GA, 30044, US

(21) Appl. No.: 11/286,729

(22) Filed: Nov. 25, 2005

(51) Int. Cl. G06Q 40/00

(52) U.S. Cl. 705/39

(57) ABSTRACT

A system that facilitates financial transactions is disclosed. In particular, the present invention relates to a vanity mailbox system that extends the presence of a business, increases the convenience to the customer of conducting financial transactions, and improves the cash flow for the business.

### FIELD OF THE INVENTION

The present invention relates to the field of remittance processing systems. In particular, the present invention relates to a vanity mailbox system that facilitates the processing of remote financial transactions.

### BACKGROUND OF THE INVENTION

Many smaller banks and financial institutions are faced with new challenges in figuring out how to compete with other larger banks for new customers while retaining their existing customer base. The past traditional approach of opening up new multiple retail branch offices and establishing a physical presence is unattractive because it is costly, time consuming, and requires significant planning and use of limited resources—especially, when there are other viable options to consider. More and more financial institutions see their future in being branchless and serving their customers in a Starbucks® coffee type of environment. The increasing ubiquity of Internet access, coupled with the prodigy of Check 21 legislation makes possible new solutions utilizing remote remittance capture services.

Historically, lockboxes or mailboxes have been used to receive payments from customers by billing aggregators, merchants, financial institutions, and banks. A lockbox is usually a post office box opened in the name of an entity but accessed and serviced by the bank or remittance processor. A lockbox reduces mail float because remittances are mailed directly to central postal processing centers, bypassing the smaller, less efficient local post office and the institution's mailroom. Special zip codes are generally used, further speeding delivery to the bank. Typically, an institution receives mail once or, at most, twice a day, while the bank may receive lockbox mail 24 hours a day, seven days a week, with up to 24 pickups each day. Many processors receive the majority of the day's mail by 5:00 a.m. Check processing and collection time is lessened with the use of lockboxes because of highly sophisticated systems and round-the-clock operation. An institution, especially a larger one, may find it beneficial to have more than one lockbox site.

There are two types of lockboxes: wholesale and retail. Wholesale lockboxes are for institutions with moderate item volume and large dollar remittances while retail lockboxes are for institutions with large item volume, and those whose payments are accompanied by machine-readable invoices. The purpose of a retail lockbox is to help manage a high volume of activity and automatically update receivables information. Typically, service charges are higher for wholesale lockboxes than for retail lockboxes because the remittance processing for wholesale lockboxes is less automated and requires faster processing to meet availability deadlines. There is a third type of lockbox that combines the processing methods of both wholesale and retail lockboxes. This combination enables the benefits of both, incorporating the automated processing of the retail lockbox with the quality data capture of the wholesale lockbox. A lockbox can contribute significantly to several of the objectives of a collection system by reducing mail float, minimizing remittance processing float, and improving check clearing or availability float.

A cash concentration system can be invaluable for institutions with geographically dispersed deposit locations, such as multiple campuses, separate operating units, state university systems, and bicoastal lockbox networks. In a concentration account system, widely distributed funds are gathered into one location and used to fund disbursement requirements. Excess funds can be swept into an investment vehicle to begin earning income rather than sitting idle in a number of different banks and accounts. The process begins when funds in the form of currency and checks are collected at multiple locations and deposited in multiple accounts in field banks. The funds from these relatively small-balance accounts are then transferred to one cash-concentration account.

The mechanisms for concentrating funds are electronic depository transfer checks (DTC), wire transfers, and zero balance accounts (ZBA). DTCs use the ACH mechanism to concentrate funds from field accounts. The electronic funds are usually available the following day. This method is generally used to concentrate recurring or small-dollar payments. Large-dollar or time-critical items are usually concentrated via FedWire to receive same-day availability. A ZBA is a deposit and/or disbursement account that provides control of balance levels of multiple accounts in the same financial institution.

More recently some companies have started using Electronic Bill and Presentment (EBPP) to send their bills directly to the customer via the Internet and anticipate that their customers will pay their bill electronically, via the Internet. The use of vanity telephone numbers for personal or business use is well known in the art. The Check 21 legislation that became effective in October 2004, giving financial institutions the choice of accepting and creating images of original checks for processing, has spawned hardware and software systems for remotely capturing check images and transmitting these images via an electronic network to financial institutions for clearing and deposit. Merging lockboxes, vanity addressing, and remote remittance capture systems together in a post-Check 21 world facilitates the creation of a vanity mailbox system that can enable businesses to cost-effectively extend their presence for receiving payments and deposits.

The typical mailing address and format often has three or four lines of text, symbols, numbers, and characters that are either hand written or printed onto the letter envelope, box, or mailing container that is to be picked up and/or placed into a mail delivery system, e.g., the U.S. Postal Service, UPS, FedExp, DHL, etc. Typically, on the first line is written the name of an individual or corporate recipient, on the second line is written the physical street address or PO Box number, and on the third line is written the City, State and zip code information, with the second and third lines directing delivery carriers to the location where the mail is to be delivered.

The use of easy to remember lettering and/or numbers has been used with vanity telephone numbers, e.g., 1-800-EYE-SEEU, automobile license plates, e.g., UGO2SLOW and Internet URL's, e.g. 1800 flowers since these types of letter-number-word combinations have the advantage of being easily remembered, readily understood, recognized, retained in long term memory, and are often used to solidify or strengthen the market messages associated with a brand.

Remote Deposit Capture often has different names depending upon how the service is applied within a particular environment. These names include Corporate Capture, Merchant Capture, Image Deposits, Image Cash Letters, etc. In general, the term Remote Deposit Capture (RDC) is increasingly used as the catch-all phrase for a family of related products and services. Each of these service family members are related in one common way: the service allows for checks to be accepted, truncated and cleared electronically. Recent legislation in the USA, commonly referred to as Check 21, makes this entire process possible. Passed in October 2003 and implemented in October 2004, this legislation allows banks to clear checks based upon images of the original items instead of having to transport the original check all the way back to the paying bank for clearing. The benefits of RDC can be substantial: convenience, reduced transportation risk & cost, better availability, processing efficiencies, the ability to consolidate banking relationships and more. RDC, in its most simple terms, is a service which allows a user to scan checks and transmit the scanned images and/or ACH-data to a bank for posting and clearing. The basic requirements for an RDC service currently include a PC, an Internet connection, a check scanner, software and a service provider such as the user's current bank. Checks received at the user's location can be scanned to create a digital deposit. This digital deposit is then transmitted (usually over an encrypted Internet connection) to the user's RDC bank service provider who then accepts the deposit, posts the deposit to the user's account, and assigns availability based upon the user's availability schedule.

The electronic bill presentment and payment process in the business-to-consumer marketplace has problems. First there are the known risks associated with the electronic initiation of payments by consumers using the Internet, e.g. phishing, pharming, account takeover, security, identification/authentication, validation. Additionally, a consumer may have to remember multiple usernames and passwords for each website in order to view and pay their bills. Also, bill consolidators/aggregators have monthly fee charges.

There is no uniformity of availability schedules for existing lockbox operations or processors of payments. Inter-city mail times also vary.

These and other problems exist. Previous attempts to solve these and other problems include the following.

U.S. Pat. No. D231,133, issued to Friedman, on Apr. 2, 1974, discloses a self-deposit receptacle for banks.

U.S. Patent Application Publication No. 2005/0192913, inventor Lubart, published on Sep. 1, 2005, discloses a postal service for routing mail objects such as an envelope or a parcel to a designated person. A user registers a pseudo name which is displayed on the mail object. The user also enters one or more profiles into a system. Various mail services may be set up by the profiles. Mail services include a follow me service allowing a user to specify a different delivery address for a date range, a mail delivery notification service, a vanity stamp service, and a bulk mail service. Changes made in the profiles take immediate effect. A payment method may be designated in a franking profile.

Lubart does not disclose the advantages of having and using the same name as a way of establishing an immediate national brand identity. Lubart does not disclose creating a visible nameplate using a vanity name as signage on a physical mailbox. Lubart does not disclose using a franchise store network. Lubart does not disclose the use or creation of a Zipcode-PMB notation for designating mailed items that are destined for a specific vanity-based mail delivery address and delivery system. Lubart does not disclose using a vanity mailbox as a way of improving the lockbox process and/or expanding the number of existing lockbox operations. Lubart does not disclose using a vanity mailing address/delivery system and zipcode-PMB as a way to minimize the risk that a business faces related to not being able to receive payments and maintain its cash flow or receive critical goods due to a USPS strike (since that delivery system ONLY delivers to a PO Box). Lubart does not disclose the combination of using a vanity mailbox as a means of offering remote capture deposit services and the processing of payments, in the form of checks, which are received for the mailbox owner recipients.

QuickPost is a relatively new deposit and payment forwarding service that is offered by NetBank and UPS as a means of receiving customer check deposits, home mortgage loan payments, or other types of payments. The customer has the means of placing their endorsed checks into a pre-printed envelope, walking into any UPS Store, and dropping the envelope off or handing it to a UPS Store associate. The UPS Store aggregates all of the received envelopes on a daily regular basis and uses next-day air delivery to fly these checks to a central processing office at no charge to the customer. After verifying that the contents and information within each envelope is correct, the consumer's account is usually credited within 1-2 days, thus reducing the mail float time and expediting the check-to-cash conversion process cycle.

QuickPost does not disclose using a plurality of personal, business, or corporate-sized vanity mailboxes as lockboxes that are leased to an individual, business owner, financial institution, bank, utility company, merchant, billing company, or government entity. QuickPost does not disclose vanity or prestige mailbox signage which appears in a convenient location on the mailbox so that it can be seen by the viewing public. QuickPost discloses individuals personally bringing their mail, but does not disclose a carrier delivery system in lieu of personal transport. QuickPost does not disclose using remote capture deposit software and technology by personnel trained to handle financial services industry transactions. QuickPost does not disclose a vanity addressing schema that can be used by all mail carriers. QuickPost does not disclose the ability to go online and select multiple different franchisee store locations, or claim and immediately start sending and receiving mailed items to these additional vanity mailboxes. QuickPost does not disclose the advantage of using the extensive 500-1000 multi-state franchisee store locations scattered across the USA and overseas to conduct a test market analysis before a bank or financial institution commits to building or establishing a permanent brick and mortar-type operation.

While this patent, published patent application and other previous methods have attempted to solve the above mentioned problems, none have utilized a vanity mailbox system. Nor has any suggested or disclosed the unique combination of the elements of vanity addressing, vanity addressing delivery, vanity mailboxes, remote deposit capture, and an internet portal as does the present invention.

Therefore, a need exists for a vanity mailbox system. The general objective of the preset invention is to provide a novel system that comprises substantial improvements in these areas.

The foregoing patent and other information reflect the state of the art of which the inventor is aware and are tendered with a view toward discharging the inventor's acknowledged duty of candor in disclosing information that may be pertinent to the patentability of the present invention. It is respectfully stipulated, however, that the foregoing patent and other information do not teach or render obvious, singly or when considered in combination, the inventor's claimed invention.

### BRIEF SUMMARY OF THE INVENTION

The general purpose of the present invention, which will be described subsequently in greater detail, is to provide a system that facilitates financial transactions. In particular, the present invention relates to a vanity mailbox system that extends the presence of a business, increases the convenience to the customer of conducting financial transactions, and improves the cash flow for the business.

The vanity mailbox system is comprised of a vanity addressing element, a vanity addressing delivery element, a vanity mailbox element, a remote deposit capture element, and an internet portal element.

The vanity addressing element condenses the traditional addressing schema. The vanity name is integrated into the areas traditionally reserved for the street address, post office box and/or zip code.

The vanity addressing delivery element is comprised of associating the vanity addressing element with the physical location for delivery. In one embodiment the delivery element is comprised of a user going to that physical location. In another embodiment the delivery element is comprised of a delivery entity, e.g. UPS, FedEx, DHL, USPS, integrating the vanity addressing schema into their delivery system and providing delivery to the physical location represented by the vanity addressing element.

The vanity mailbox element may be:
a box with signage on the front that denotes a vanity mailing address for receipt of mail that is either personally delivered or brought by a mail delivery service; and/or
a free-standing mailbox receptacle that is typically located on a street corner, a sidewalk, at the curbside, within, or adjacent to a building and that is useful for the receipt of mail or parcels that is dropped into it and later retrieved by a mail delivery system employee.
   The free-standing mailbox receptacle would not have a vanity mailing address associated with it nor have a vanity mailing address physically located on the box; however, it may have a distinctive pattern, color, or logo that allows it to be readily recognized by the public and the commercial and/or privately owned mail delivery systems.

The vanity mailbox element that resides in a physical location, e.g. the UPS Store, Mailbox It, Parcel Plus, PostNet, would have distinctive signage. Instead of the business owner or a corporate leasee being assigned a random number or alphanumeric P.O. Box number for use as a mailing delivery address, the name of the business or the corporation will be either printed, embossed, engraved, or possibly etched onto the front facing of the vanity mailbox using an attractive uniform standard type and style of font in, order to create a permanent unique and appealing vanity business or corporate name label and signage.

This newly created printed, embossed, engraved or etched vanity name label and signage will replace the random alphanumeric text and numbers that now exists on the front facing of a traditional mailbox and which currently serves to make up the P.O. Box mailing address. The vanity name label and signage on the front of the vanity mailbox will be clearly legible and visible to the viewing public and may be visible on all sides of the vanity mailbox. In one embodiment, the vanity mailbox element is a receptacle that serves as a drop box for the acceptance and collection of packages or letters. These drop boxes may be distributed at a USPS office, station, branch or retail facility, strip mall, or business park office for the acceptance and collection of vanity mail items and shipments. This drop box may be located indoors or outdoors, depending on factors such as level of customer traffic, availability of parking, traffic flow, visibility, etc. The design of the drop box may be similar in its size, shape and dimensions to current boxes, e.g. the Fedex model of 53 inches high, 27 inches wide, 30 inches deep. The drop box would be differentiated by its distinctive colors, pattern, logo and/or signage. The drop box may be designed to allow easy maintenance, mechanical repair, site placement, removal, etc.

The remote deposit capture element is comprised of distinctive containers, e.g. envelopes, within which the individual transactions are transported to and/or received at a location where remote deposit hardware, software and staff process the transactions, transmit the transactions into the appropriate financial network and update the appropriate accounts. At each location with co-located remote deposit capture service, there may be a separate secure non-public area that will have the remote deposit capture scanner technology, software, and equipment and trained staff to operate it. This area would be staffed by experienced trained personnel who would perform the remote deposit capture and imaging of any checks that a business owner or corporation would receive in their vanity mailbox. If the remote deposit capture processing is not co-located at a site location, then trained staff could travel between each location within a certain defined geographic area on a regular daily schedule and provide the remote deposit capture imaging services at various times throughout the day upon arrival at the new location using mobile facilities. Alternatively, the contents of each vanity mailbox could be picked up and transported to a centralized location for processing.

The internet portal element facilitates clients claiming, establishing, changing, monitoring, and discontinuing their leased vanity mailboxes in the desired locations.

The above combined elements can be readily implemented by a bank as well as a SOHO, individual small business owner or a corporation as a means of expanding its business and capture market share. By changing the format of its mailing address and substituting a vanity mailbox for its traditional brick-and-mortar retail branch office, a bank can quickly and easily establish multiple convenient locations nationwide with very little effort and costs. At each of these locations imaging technology can be used to serve its customers by accepting, sending, and receiving deposits that its customers drop off, pickup, or deliver—as well as any other received written communications, packages, parcels, and hand-carried items and process these items in a timely manner via an efficient delivery system.

In one embodiment a bank could easily establish multiple new retail branch offices and start accepting and processing remote deposits virtually overnight by entering into a nationwide agreement with a major Mail, Packaging, and Shipping franchisor and establishing a vanity mailbox address at each of their franchisee locations. The bank would then simply need to install remote deposit capture imaging technology and hire a small 2-4 person staff for each site to operate the equipment and ensure that the checks being accepted are eligible of being processed. By using their newly established network of retail branch offices as leverage, a bank could then negotiate very favorable leasing terms and conditions with vendors who supply remote image capture deposit technology and software, e.g., Advanced Financial Solutions, Goldleaf Technologies, Panini scanners, Wausau Financial Systems, and realize significant cost savings. These cost savings result from not having to hire a realtor to locate or purchase a piece of property, or incur expenses due to construction costs, signage, legal work, or time delay in dealing with planning and zoning commissions, all of which could easily cost between $250K-750K per site, before the first customer walks into the door of a new branch office.

One advantage of the present invention is that it improves the cash flow of a business and provides a means of public fund-raising for national, state, county and local political candidates and their campaign organizations, and enhances the means by which charitable and non-profit organizations can raise annual contributions.

Another advantage of the present invention is that it provides a cost effective alternative to purchasing/leasing expensive real estate for a branch office.

Another advantage of the present invention is that is extends the reach of a business.

Another advantage of the present invention is that it increases the visibility of the brand of a business.

Another advantage of the present invention is that it enables a business to create the perception of being a large growing company and to establish a powerful channel of communication between itself and its new or existing B2B and/or C2B customers.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further objects and advantages of the present invention will be apparent from the following detailed description of a presently preferred embodiment which is illustrated schematically in the accompanying drawings.

### BRIEF DESCRIPTION OF THE SEVERAL VIEWS OF THE DRAWINGS

Other advantages and features of the invention are described with reference to exemplary embodiments, which are intended to explain and not to limit the invention, and are illustrated in the drawings in which:

FIG. 1 illustrates the steps to implement a vanity mailbox system, according to a preferred embodiment of the present invention.

FIG. 2 illustrates a plurality of vanity mailbox addresses, according to an embodiment of the present invention.

FIG. 3 illustrates a plurality of vanity mailbox addresses, according to an embodiment of the present invention.

FIG. 4 illustrates the steps to establish a vanity mailbox network, according to an embodiment of the present invention.

FIG. 5 illustrates the steps to deliver items to a vanity mailbox location utilizing a delivery service, according to an embodiment of the present invention.

FIG. 6 illustrates the steps to deliver items to a vanity mailbox location by personal delivery, according to an embodiment of the present invention.

FIG. 7 illustrates the steps to transport items from a vanity mailbox to a remote processing location, according to an embodiment of the present invention.

FIG. 8 illustrates the steps to take items from a vanity mailbox to a co-located processing location, according to an embodiment of the present invention.

FIG. 9 illustrates the steps to process items retrieved from a vanity mailbox, according to an embodiment of the present invention.

### DETAILED DESCRIPTION OF THE INVENTION

Before explaining the disclosed embodiment of the present invention in detail it is to be understood that the invention is not limited in its application to the details of the particular arrangement shown since the invention is capable of other embodiments. Also, the terminology used herein is for the purpose of description and not of limitation.

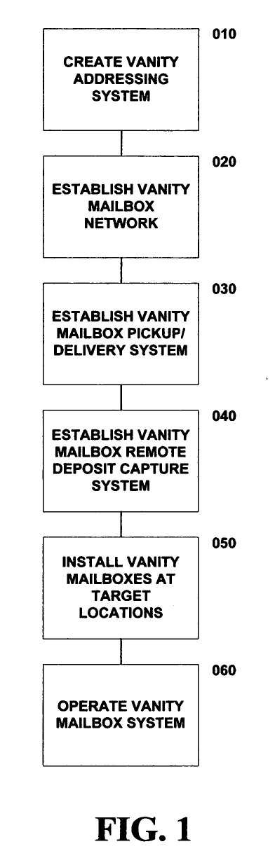

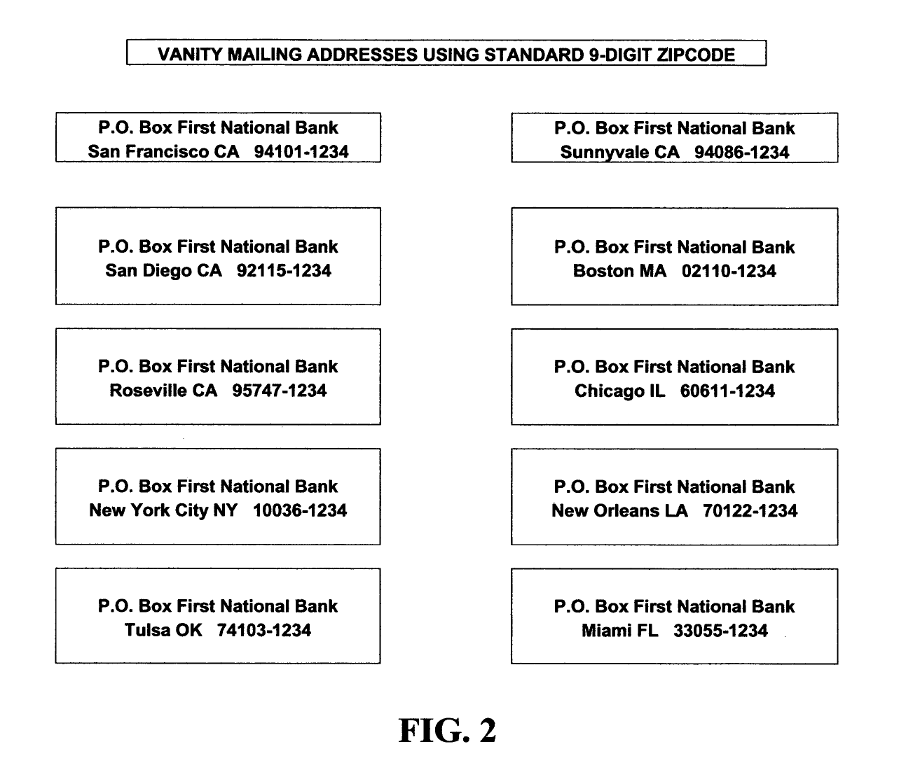

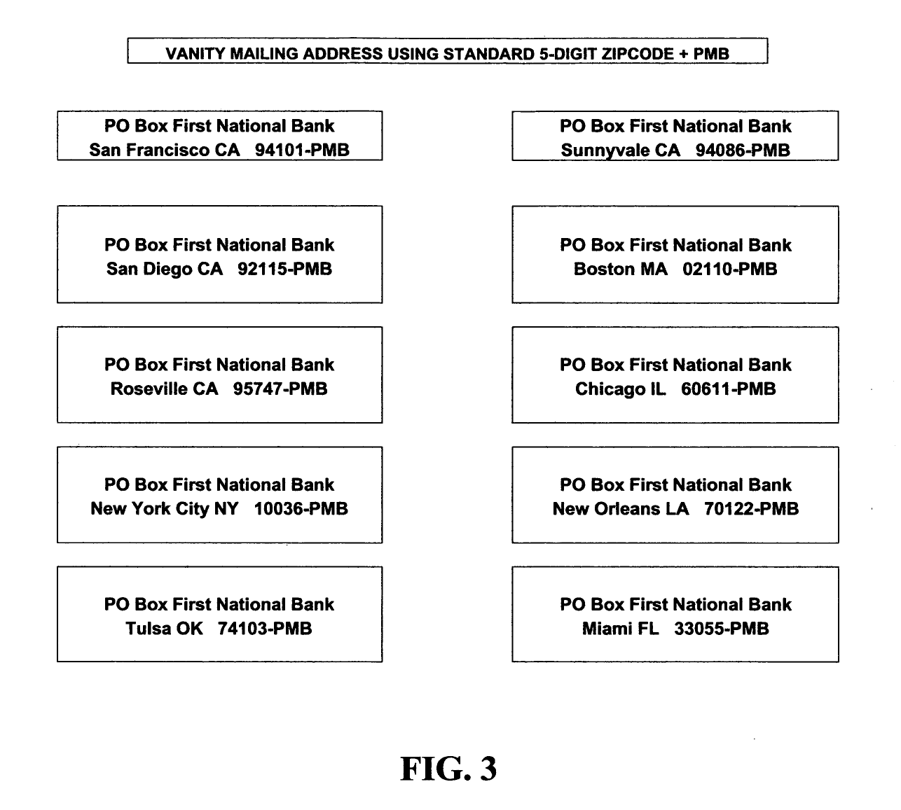

Referring now to FIG. 1, at step 010, a vanity addressing system is created by standardizing a format that can be utilized by delivery carriers to recognize the delivery location for each address. FIG. 2 illustrates utilizing a P.O. Box format where the entity name follows the P.O. Box designation. FIG. 3 illustrates utilizing a P.O. Box format combined with a PMB designation following the zip code. Other formats utilizing the line traditionally used for street or P.O. box, and/or the line traditionally used for City, State and Zip Code, are encompassed by the present invention. It is envisioned that a single format will be used and adopted by delivery carriers to facilitate the efficient sorting and delivery of mail.

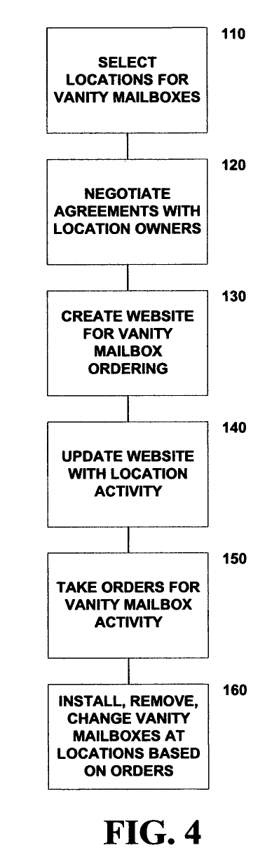

Referring now to FIG. 1, at step 020, a vanity mailbox network is established. FIG. 4 illustrates steps 110 and 120 to secure locations for placement of vanity mailboxes. In steps 130 and 140 a website is created and populated with available locations in which a user can claim, establish, change, monitor or discontinue their selected vanity mailboxes installed. In steps 150 and 160, orders are taken and vanity mailboxes are installed or removed, and other changes are made.

Referring now to FIG. 1, in step 030, the vanity mailbox delivery system is established. In addition to an individual personally delivering one or more items into a facility having at least one vanity mailbox, delivery service carriers will accommodate the vanity mailbox addressing schema and properly route mail to the appropriate vanity mailbox location.

Referring now to FIG. 1, in step 040, a vanity mailbox remote deposit capture system is established and installed to service the contents of each vanity mailbox. This remote deposit capture system may be co-located at the vanity mailbox location, may be located remote to the vanity mailbox location, or may be located in a mobile facility. The remote deposit capture system is comprised of at least one scanner, at least one PC, at least one high speed connection to the Internet, and software for capturing, processing and transmitting remittance documents and scanned images.

Referring now to FIG. 1, in step 050, vanity mailboxes are installed at the vanity mailbox locations based on orders received on the vanity mailbox web site.

Referring now to FIG. 1, in step 060, the vanity mailbox system is operational. Through the web site, users can place orders for vanity mailboxes, check on status, receive transaction reports, etc. The vanity mailbox web site allows a business owner or corporation to select one or more existing or future planned franchisee store locations from a screen, and place an order for a vanity mailbox. If the vanity name already exists or has already been assigned at a given location, then the business owner would need to select a different franchisee store location, go on a waiting list until another franchisee store in that location had a vanity mailbox available, or if need be, change the planned name. Each client has the option of receiving email notifications when there is activity at a vanity mailbox, e.g., check deposits have been processed, availability of a new vanity mailbox location.

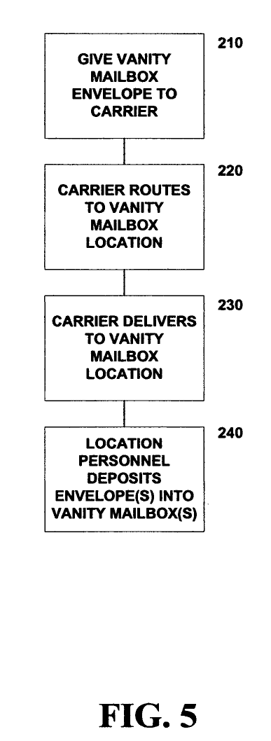

FIG. 5 illustrates the steps for an individual to give mail to a delivery service carrier and for that mail to be deposited into the appropriate vanity mailbox. In step 210 mail is given to a delivery service provider. In step 220, the carrier performs those functions to associate the vanity address with the physical location of a corresponding vanity mailbox location. In step 230, the carrier delivers mail to the vanity mailbox location. In step 240, staff at the vanity mailbox location deposits mail into each vanity mailbox.

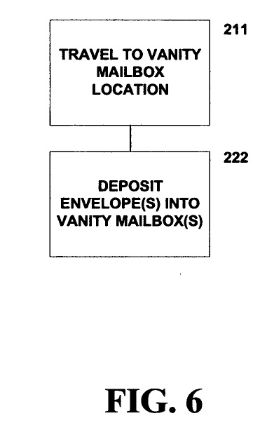

FIG. 6 illustrates the steps for an individual to personally deliver mail to a vanity mailbox location. In step 211, the individual travels to the vanity mailbox location. In step 222, the individual deposits the mail into the vanity mailbox.

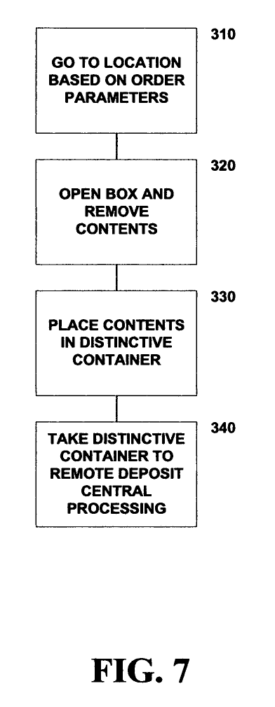

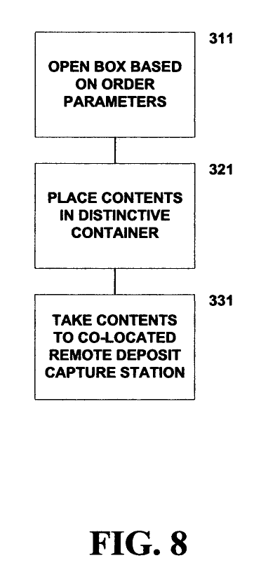

FIG. 7 illustrates the steps where the remote deposit capture system is not co-located with a vanity mailbox. In steps 310, 320, 330, and 340, staff goes to the vanity mailbox location, opens the vanity mailbox, places the contents into a distinctive container, e.g. an envelope, and takes the distinctive container to the location where the remote capture station is located. FIG. 8 illustrates the steps where the remote capture system is co-located with a vanity mailbox. In step 311 the vanity mailbox is opened; in step 321 the contents are placed in a distinctive container; in step 331, the contents are taken to the co-located remote deposit capture station.

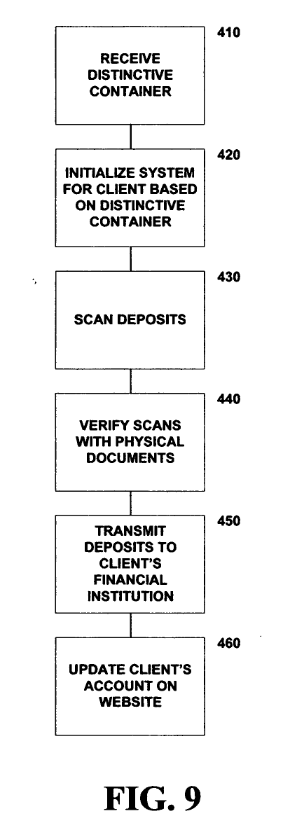

FIG. 9 illustrates the steps at the remote deposit capture station, whether it is co-located with the vanity mailbox location, mobile or remote from the vanity mailbox location. In step 410, the distinctive container is received and the contents removed. In step 420 the system is initialized for the client. In step 430 the remittances and control documents are scanned. In step 440 the scanned images are verified against the physical documents. In step 450, the scanned images are transmitted to the financial institution designated by the client. In step 460, the client's account is updated at the password protected portion of the vanity mailbox website.

What is claimed is:

1. A vanity mailbox system for facilitating the processing of financial transactions comprising:
means for identifying a vanity mailbox,
means for operating said vanity mailbox system,
means for delivering said financial transactions to said vanity mailbox,
means for receiving said financial transactions within said vanity mailbox, and
means for processing said financial transactions.

2. The vanity mailbox system of claim 1, wherein said means for identifying a vanity mailbox is comprised of:
selecting a vanity name;
using said vanity name to create a vanity delivery address in a format selected from the group comprised of (P.O. Box vanity name, city, state zip code; P.O. Box vanity name, city, state, zip code-PMB);
placing said vanity name on said vanity mailbox.

3. The vanity mailbox system of claim 2, wherein said means for operating said vanity mailbox system is comprised of:
selecting a plurality of a location for placement of a plurality of said vanity mailbox;
negotiating an agreement with owner of said location;
creating a website for ordering of at least one of said vanity mailbox;
updating said website with location information;
taking orders for vanity mailbox activity; and,
processing said orders for vanity mailbox activity.

4. The vanity mailbox system of claim 3, wherein said means for delivering said financial transactions to said vanity mailbox is comprised of:
giving a vanity mailbox envelope having a vanity mailbox address to a delivery carrier;
associating said vanity mailbox address with a physical location where said vanity mailbox is located;
transporting said vanity mailbox envelope to said physical location;

5. The vanity mailbox system of claim 4, wherein said means for receiving said financial transactions within said vanity mailbox is comprised of:
inserting said vanity mailbox envelope into said vanity mailbox.

6. The vanity mailbox system of claim 5, wherein said means for processing said financial transactions is comprised of:
removing a plurality of said vanity mailbox envelope from said vanity mailbox;
placing said plurality of said vanity mailbox envelope into a vanity mailbox container;
transporting said vanity mailbox container to a remote transaction processing station;
initializing said remote financial transaction processing station based on client information associated with said vanity mailbox container;
scanning said financial transactions to create scanned images;
verifying said scanned images with said financial transactions;
transmitting said scanned images to a financial institution associated with said client information;
updating client account information on said web site.

7. The vanity mailbox system of claim 6, wherein said financial transactions are deposits and associated financial documents, said remote transaction processing station is a remote deposit capture station and said financial institution is a bank.
